(19) United States
(12) Patent Application Publication
(10) Pub. No.: US 2005/0205273 A1
(43) Pub. Date: Sep. 22, 2005

(54) Method for driving electric percussion tool

(76) Inventors: Chih Hao Yiu, Taichung (TW); Shun Chien Chen, Taichung (TW)

Correspondence Address: CHARLES E. BAXLEY, ESQ., 90 JOHN STREET, 3RD FLOOR, NEW YORK, NY, 10038, US

(21) Appl. No.: 10/805,051

(22) Filed: Mar. 19, 2004

(51) Int. Cl. B25D 1/00

(52) U.S. Cl. 173/1; 173/117

(57) ABSTRACT

A method for driving an electric percussion tool which includes a plunger core actuatable by a solenoid to conduct the striking or hammering or driving operation, and a spring member to recover the plunger core back to the original position after the striking or hammering or driving operation. A longer time interval may be provided between every two driving signals, to allow the spring member to be made of weaker materials, and to prevent the spring member from overcoming a great portion of the driving force of the solenoid, and thus to increase the driving force of the solenoid acted onto the plunger core.

### BACKGROUND OF THE INVENTION

1. Field of the Invention

The present invention relates to a method for driving tools, and more particularly to a method for driving electric hammer or impact or percussion tools.

2. Description of the Prior Art

Various kinds of typical electric percussion tools, impact beating tools, or the like have been developed and provided for hammering or stapling or nailing purposes, and comprise a plunger core slidably received in a coil or solenoid, which may actuate or force the plunger core to move and thus to hammer or impact onto objects.

For example, U.S. Pat. No. 4,183,453 to Barrett et al, and U.S. Pat. No. 4,215,297 to Jacquemet disclose two of the typical electric percussion tools, impact beating tools, or the like and comprise a single plunger core slidably received in a single solenoid, and a spring member for recovering the plunger core back to the original position, or away from the middle portion of the solenoid.

In operation, the plunger core may be forced to move toward the middle portion of the solenoid every time when the solenoid is energized. The spring member is provided for recovering or moving the plunger core away from the middle portion of the solenoid after every striking or hammering or driving operation, for allowing the solenoid to actuate or move the plunger core next time.

However, a portion of the striking or hammering or driving forces of the plunger core applied thereto by the solenoid may be overcome by the spring biasing force of the spring members, such that the striking or hammering or driving force of the plunger core is small or less, and such that the plunger core has to be forced or actuated many times, in order to conduct the striking or hammering operation many times.

If the spring members are made weaker, the hammering or striking or driving forces of the plunger core may be easily used to hammer or impact onto the objects, but the weaker spring members may not be used to easily or quickly recover or move the plunger core away from the middle portion of the solenoid after every striking or hammering or driving operation.

On the contrary, when the spring members are made stronger, a great portion of the striking or hammering or driving forces of the plunger core may be overcome by the spring biasing force of the spring members, such that the plunger core may not be used to effectively hammer or impact or strike onto the objects.

In order to improve the small striking or hammering problems, another typical electric percussion tool has been developed to provide two or more solenoids to drive the plunger core in series, in order to produce high impact forces against the work pieces.

For example, U.S. Pat. No. 5,760,552 to Chen et al. and U.S. Pat. No. 6,364,193 to Tsai disclose two of the typical impact devices. However, a complicated configuration may be formed and a number of members or elements are required to be provided to form the electromagnetic high energy pulse coil device, such that the volume and weight and manufacturing cost of the may be greatly increased.

U.S. Patent Application No. U.S. 2002/0014344A1 to Geiger et al. discloses a further typical electric percussion tool which includes two coils or solenoids having an axis disposed or extended transverse to the oscillation axis of a working tool. Similarly, a complicated configuration and a number of members or elements are required to be provided to form and to arrange the electro-magnetic hammer and a yoke thereof.

The present invention has arisen to mitigate and/or obviate the afore-described disadvantages of the conventional methods for driving electric percussion tools.

### SUMMARY OF THE INVENTION

The primary objective of the present invention is to provide a method for driving electric percussion tool and to allow the spring member to be made of weaker materials, and to prevent the spring member from overcoming a great portion of the striking or hammering forces of the plunger core applied thereto by the solenoid, and thus to increase the driving force acting onto the plunger core while conducting the striking or hammering operations.

In accordance with one aspect of the invention, there is provided a method for driving an electric percussion tool, the electric percussion tool includes a solenoid, a plunger core slidably received in the solenoid and actuatable by the solenoid to move relative to the solenoid, and a spring member for applying a spring biasing force against the plunger core to recover the plunger core relative to the solenoid. The method comprises providing a first positive signal, one or more second positive signals, and a third positive signal to operate the solenoid. The first and the third positive signals are provided to energize the solenoid to actuate the plunger core to slide relative to the solenoid, from a first position to a second position, and to conduct two driving operations. The second positive signal is provided to de-energize the solenoid, and to allow the plunger core to be recovered back from the second position to the first position by the spring member, and to allow the spring member to have a longer time to recover the plunger core from the second position to the first position, and to allow the spring member to be made with a smaller spring biasing force.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a schematic view illustrating a method in accordance with the present invention to operate or actuate an electric percussion tool, in which a number positions of the electric percussion tool have been shown in correspondence to trigger or actuating signals;

FIG. 2 is a plan schematic view illustrating an actuating electric circuit for driving or actuating or operating the electric percussion tool; and

FIG. 3 is a schematic view illustrating the driving signals for actuating the solenoid of the electric percussion tool.

### DETAILED DESCRIPTION OF THE PREFERRED EMBODIMENT

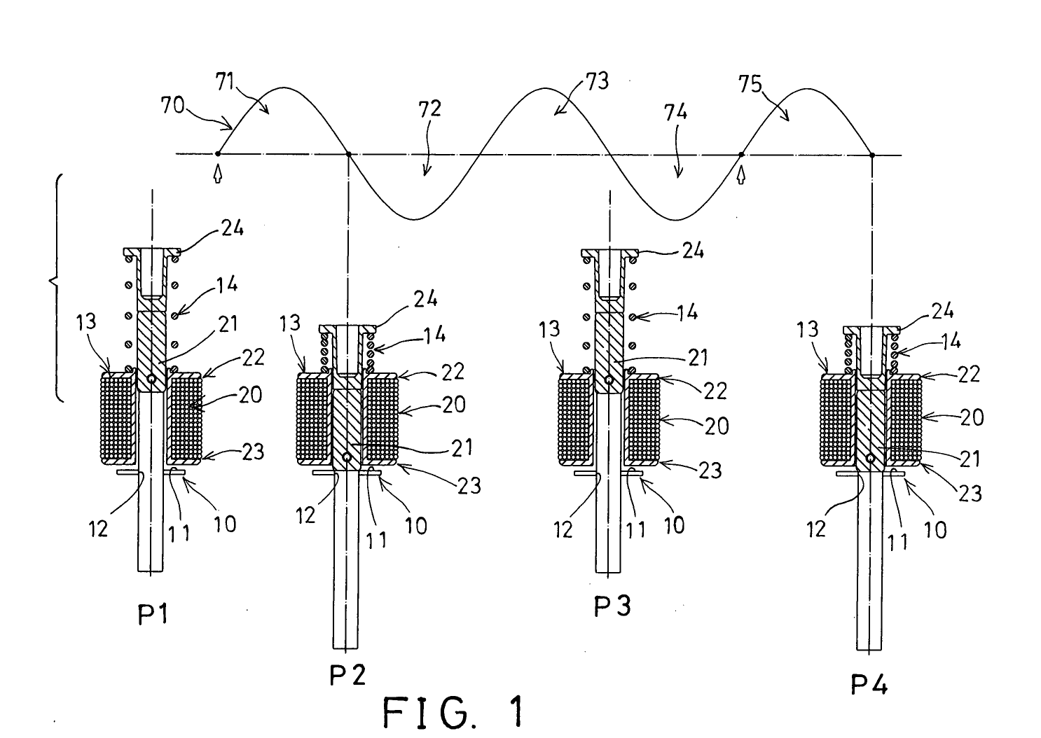

Referring to the drawings, and initially to FIG. 1 an electric percussion tool to be driven or operated by a method in accordance with the present invention comprises a housing 10 including a chamber 11 formed therein, and including an opening 12 formed in one end thereof and communicating with the chamber 11 thereof.

One or more coils or solenoids 20 may be disposed in the middle portion of the chamber 11 of the housing 10, and received in such as a casing 13. A plunger core 21 is slidably received in the solenoid(s) 20, and to be forced or actuated by the solenoid 20 to move relative to or to move into the solenoid 20, as shown in positions P2 and P4 of FIG. 1.

The plunger core 21 is arranged to be partially movable out of one end 22 of the solenoid 20, but may not be completely or fully moved out of the one end 22 of the solenoid 20, but may also be arranged to be completely or fully movable out of the other end 23 of the solenoid 20, when required.

A spring member 14 is disposed in the chamber 11 of the housing 10 and preferably disposed distal to the opening 12 of the housing 10, and preferably disposed out of the solenoid 20. The plunger core 21 includes a projection 24 extended from one end thereof to engage with the spring member 14.

The spring member 14 may thus be engaged between the plunger core 21 and the casing 13 or the solenoids 20, to bias or recover the spring member 14 back to the position where the plunger core 21 is completely or fully or partially moved or located out of the solenoids 20, as shown in positions P1 and P3 of FIG. 1.

Several of the examples of the electric percussion tools have been disclosed and described in the cited arts, which may thus be taken as references for the present invention. The electric percussion tool may be used for nailing or stapling or hammering purposes.

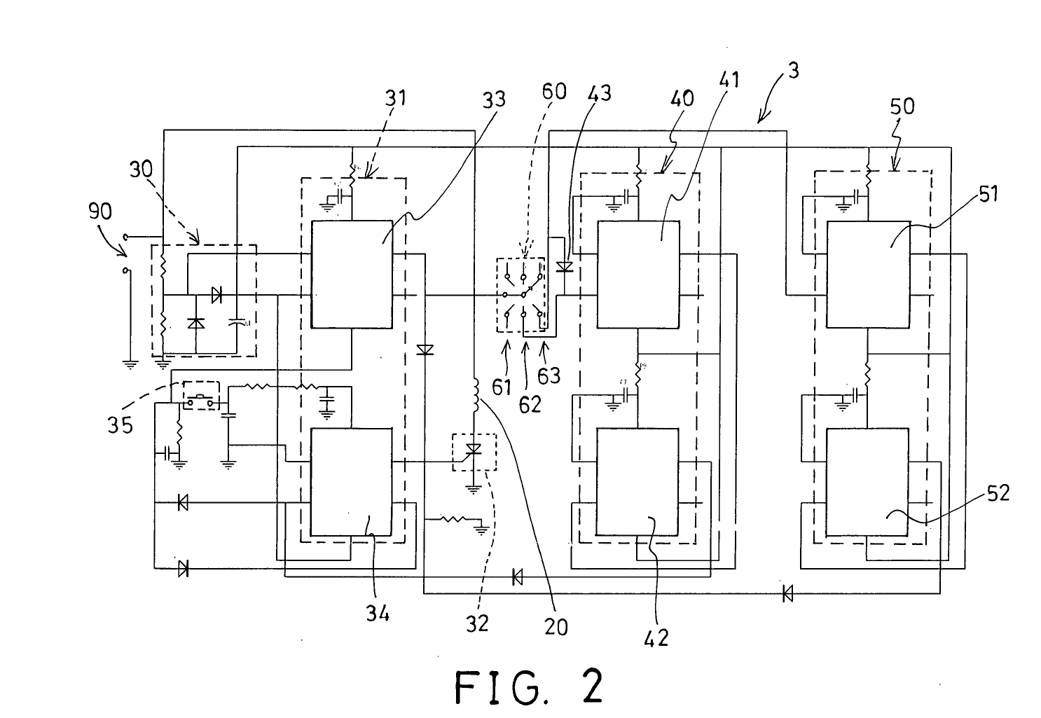

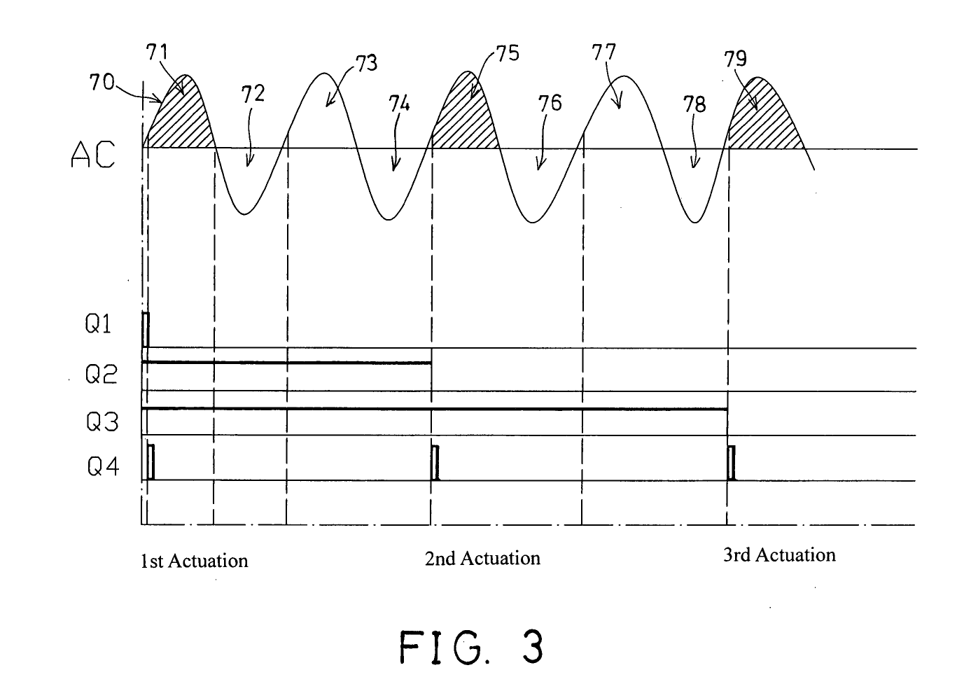

Referring next to FIG. 2, illustrated is one example of an actuating electric circuit 3 for driving or actuating or operating the electric percussion tool as shown in FIG. 1. The actuating electric circuit 3 includes a rectifying circuit 30 coupled to an electric power supply 90 to rectify the electric energy from the electric power supply 90, and to allow only the positive sine wave or pulse or driving signals 71, 73, 75, 77, 79 (FIG. 3) to pass through the rectifying circuit 30.

For example, as shown in FIG. 3, a number of consecutive sine wave or pulse signals 71-79 . . . will be generated by the electric power supply 90, and the rectifying circuit 30 may be used to rectify the sine wave or pulse signals 71-79, and to allow only the positive sine wave or pulse or driving signals 71, 73, 75, 77, 79 (FIG. 3) to pass through the rectifying circuit 30 and to actuate the electric percussion tool as shown in FIG. 1. The negative sine wave or pulse signals 72, 74, 76, 78 may not be used to actuate or to drive the electric percussion tool.

The actuating electric circuit 3 includes a counting circuit 31 coupled to the rectifying circuit 30, and coupled to the solenoid 20 via a triggering or actuating device 32, such as a silicon controlled rectifier (SCR) 32 which may be used to trigger or actuate the solenoid 20. The counting circuit 31 includes two integrated circuits (IC) 33, 34 coupled together, and coupled to the rectifying circuit 30 and the actuating device SCR 32 respectively.

The actuating electric circuit 3 further includes a switch 35 coupled to the counting circuit 31, such as coupled to the ICs 33, 34 of the counting circuit 31, for triggering or initializing the actuating electric circuit 3. For example, when the switch 35 is depressed or actuated by the users, a positive sine wave or pulse or driving signal 71 may be sent from the rectifying circuit 30 to the counting circuit 31.

When the positive sine wave or pulse or driving signal 71 has been sent to the IC 33 of the counting circuit 31, the IC 33 will send out a signal to the other IC 34 of the counting circuit 31, in order to actuate the actuating device SCR 32 and then to actuate the solenoid 20 of the electric percussion tool.

As shown in FIG. 1, when the solenoid 20 is actuated by the positive sine wave or pulse or driving signal 71, the plunger core 21 may be actuated or drawn by the solenoid 20 against the spring biasing force of the spring member 14, to move into the solenoid 20, from the position P1 to P2, in order to conduct the striking or hammering or driving operations.

After the striking or hammering or driving operation and after being actuated by the positive sine wave or pulse or driving signal 71, a negative sine wave or pulse signal 72 will be sent to the counting circuit 31. At this moment, the actuating device SCR 32 and the solenoid 20 will not be energized or will be de-energized, such that the spring member 14 may be used to bias or to recover the plunger core 21 from the position P2 to P3.

Referring again to FIG. 2, the actuating electric circuit 3 further includes one or more, such as two counting circuits 40, 50 coupled together in series, and coupled to the counting circuit 31 via another switch 60. Each of the counting circuits 40, 50 may include two integrated circuits (IC) 41, 42; and 51, 52 coupled together, and coupled to the counting circuit 31 via the switch 60.

The switch 60 includes two or more terminals 61, 62, 63 for selectively actuating the counting circuits 31, 40, 50. For example, when the switch 60 is coupled or switched to the terminal 61, only the counting circuit 31 may be operated and actuated by the first positive sine wave or pulse or driving signal 71 (FIG. 3). At this moment, the solenoid 20 of the electric percussion tool may be actuated to conduct the striking or hammering or driving operation.

When the switch 60 is coupled or switched to the other terminal 62, both the counting circuits 31, 40 may be operated and actuated by the driving signal 70. With this connection, when the first counting circuit 31 received the positive sine wave or pulse or driving signal 71 from the rectifying circuit 30, the first IC 33 of the first counting circuit 31 will also issuing or sending a trigger signal to the IC 41 of the second counting circuit 40, to actuate the second counting circuit 40 to start or to conduct a counting operation.

The IC 41 of the second counting circuit 40 may be preset to a predetermined value, such as four half wave signals or two complete sine wave signals. When the solenoid 20 is actuated to conduct the striking or hammering or driving operation by the first positive sine wave or pulse or driving signal 71, the IC 41 of the second counting circuit 40 may be started to count the four half wave signals 71-74 or the two complete sine wave signals that have been predetermined or previously entered into the IC 41 of the second counting circuit 40.

For example, when IC 41 of the second counting circuit 40 has counted the predetermined four half wave signals 71-74 or two complete sine wave signals, the IC 41 of the second counting circuit 40 may be actuated by the following fifth half wave signal 75 or the third positive wave signal 75, to actuate the IC 42 to actuate the actuating device SCR 32 directly, or indirectly via the IC 34 of the counting circuit 31, and then to actuate the solenoid 20 to conduct another or a second striking or hammering or driving operation. At this moment, the plunger core 21 may be actuated by the solenoid 20 to move from the position P3 to P4. The spring member 14 may then recover the plunger core 21 from the position P4 to P1 or P3 or the like after the solenoid 20 has been actuated by the third positive wave signal 75.

It is to be noted that the counting circuit 40 may thus be arranged to actuate the solenoid 20 with the third positive wave signal 75 or within the time interval of the third positive wave signal 75, but not the second positive wave signal 73. In such a situation, the solenoid 20 will not be actuated, or will be de-energized for three half wave signals 72-74, and the spring member 14 may have much more time to bias and to recover the plunger core 21 from the position P2 to P3.

After the IC 42 has been actuated by the IC 41 of the second counting circuit 40, the second counting circuit 40 will be reset or terminated automatically, and may then only be actuated or operated by the first IC 33 of the first counting circuit 31 after the switch 35 is depressed or actuated by the users again. The second counting circuit 40 will be terminated and may not be actuated or operated by the first IC 33 of the first counting circuit 31 again even when the switch 35 is continuously depressed by the users, or when the switch 35 has not be released by the users and depressed again.

Correspondingly, the spring member 14 is not required to be made of a stronger spring biasing force, and may be made of a weaker or smaller spring biasing force, and may thus have a longer time to recover the plunger core 21 back to the original position where the solenoid 20 has not been actuated or energized or when the solenoid 20 is de-energized. Relatively, when the spring member 14 is made of a weaker or smaller spring biasing force, the solenoid 20 may be actuated against a relatively weaker spring member 14, and may thus be operated to actuate the plunger core 21 with a relatively greater force.

Similarly, when the switch 60 is coupled or switched to the further terminal 63, the counting circuits 31, 40, 50 may all be operated and actuated by the driving signal 70. With this connection, when the first counting circuit 31 received the positive sine wave or pulse or driving signal 71 from the rectifying circuit 30, the first IC 33 of the first counting circuit 31 will also issuing or sending a trigger signal to the ICs 41, 51 of the other counting circuits 40, 50 to actuate the counting circuits 40, 50 to start or to conduct the counting operations.

The IC 51 of the third counting circuit 50 may also be preset to a predetermined value, such as eight half wave signals or four complete sine wave signals. When the solenoid 20 is actuated to conduct the striking or hammering or driving operation by the first positive sine wave or pulse or driving signal 71, the IC 51 of the third counting circuit 50 may also be started to count the predetermined eight half wave signals 71-78 or the four complete sine wave signals.

For example, when IC 51 of the third counting circuit 50 has counted the predetermined eight half wave signals 71-78 or four complete sine wave signals, the IC 51 of the third counting circuit 50 may be actuated by the following ninth half wave signal 79 or the fifth positive wave signal 79, to operate the IC 52 to actuate the actuating device SCR 32 directly, or indirectly via the IC 34 of the counting circuit 31, and then to actuate the solenoid 20 to conduct another or a third striking or hammering or driving operation.

It is to be noted that the counting circuit 50 may thus be arranged to actuate the solenoid 20 with the fifth positive wave signal 79 or within the time interval of the fifth positive wave signal 79, but not the fourth positive wave signal 77. In such a situation, the solenoid 20 also will not be actuated, or will be de-energized for three half wave signals 76-78, and the spring member 14 may also have much more time to bias and to recover the plunger core 21 from the position P2 to P3.

For example, if it takes a predetermined time interval, such as one (1) second for each of the half wave signals 71-79, then the solenoid 20 will be actuated at the first second, the fifth second, the ninth second, the thirteenth second, . . . and the like. Alternatively, two (2) or more seconds for two or more half wave signals 72-74, or a time interval of two or more times of the one second time interval of either of the actuating signals 71, 75 may be formed or provided between the two actuating signals 71, 75, and not to actuate the solenoid 20, or to de-energize the solenoid 20, and to have much more time to have the spring member 14 to bias and to recover the plunger core 21.

After the IC 52 has been actuated by the IC 51 of the third counting circuit 50, the third counting circuit 50 will be reset or terminated automatically, and may then only be actuated or operated by the first IC 33 of the first counting circuit 31 after the switch 35 is depressed or actuated by the users again. The third counting circuit 50 will be terminated or may not be actuated or operated by the first IC 33 of the first counting circuit 31 again even when the switch 35 is continuously depressed by the users, or when the switch 35 has not be released by the users and depressed again.

Alternatively, between the two actuating signals 71, 75, one or more signals 73 may be arranged not to actuate the solenoid 20, or to de-energize the solenoid 20, and to have much more time to have the spring member 14 to bias and to recover the plunger core 21.

The prior electric percussion tools fail to provide a solenoid 20 which may be actuated with the driving signals having one or more positive signals provided between the driving signals and that will not be used to actuate the solenoid 20, or to de-energize the solenoid 20, and to allow the spring member 14 to be made of a weaker or a smaller spring biasing force, and for preventing most of the force of the solenoid 20 from acting against the spring member 14.

Accordingly, the method for driving electric percussion tools may be used for allowing the spring member to be made of weaker materials, and to prevent the spring member from overcoming a great portion of the striking or hammering or driving forces of the plunger core applied thereto by the solenoid, and thus to increase the driving force of the solenoid acted onto the plunger core while conducting the striking or hammering or driving operations.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. A method for driving an electric percussion tool, said electric percussion tool including a solenoid, a plunger core slidably received in said solenoid and actuatable by said solenoid to move relative to said solenoid, a spring member for applying a spring biasing force against said plunger core to recover said plunger core relative to said solenoid, and a switch for initializing said solenoid, said method comprising:
initializing said solenoid with said switch,
providing a first positive signal to energize and to operate said solenoid for a first time interval to actuate said plunger core to slide relative to said solenoid, from a first position to a second position, and to conduct a first driving operation,
providing at least one second positive signal to deenergize said solenoid for a second time interval, to allow said plunger core to be recovered back from said second position to said first position by said spring member,
providing a third positive signal to energize and to operate said solenoid again for a third time interval to actuate said plunger core to slide relative to said solenoid, from said first position to said second position, and to conduct at least one second driving operation, and
terminating said solenoid,
said second time interval being arranged longer than said first time interval, to allow said spring member to have a longer time to recover said plunger core from said second position to said first position, and to allow said spring member to be made with a smaller spring biasing force.

2-3. (canceled)
